(19) United States
(12) Patent Application Publication
(10) Pub. No.: US 2010/0036797 A1
(43) Pub. Date: Feb. 11, 2010

(54) SEMANTIC SEARCH ENGINE

(75) Inventors: Willy WaiHo Wong, San Diego, CA (US); Maryann E. Martone, La Jolla, CA (US)

Correspondence Address: GREER, BURNS & CRAIN, 300 S WACKER DR, 25TH FLOOR, CHICAGO, IL, 60606, US

(73) Assignee: THE REGENTS OF THE UNIVERSITY OF CALIFORNIA, Oakland, CA (US)

(21) Appl. No.: 12/375,603

(22) PCT Filed: Aug. 31, 2007
(86) PCT No.: PCT/US2007/019129

§ 371 Date: Mar. 4, 2009

Related U.S. Application Data
(60) Provisional application No. 60/841,356, filed on Aug. 31, 2006.

(51) Int. Cl. G06N 5/02; G06F 17/30

(52) U.S. Cl. 706/55; 707/5; 707/E17.014

(57) ABSTRACT

Systems and methods for populating a database. An ontology is parsed to determine a plurality of keywords. A string-based search engine is utilized to perform a search of documents on a network based on the determined keywords, and at least one document is retrieved. A relation is established between the retrieved document and the ontology, and it is determined if the at least one document is to be stored in the database based on the established relation. If so, the document is stored in the database. The database can be used as part of a standalone or plug-in search engine for retrieving online documents.

### PRIORITY CLAIM

This application claims the benefit of U.S. Provisional Application Ser. No. 60/841,356, filed Aug. 31, 2006, under 35 U.S.C. §119.

### TECHNICAL FIELD

A field of the invention is computer-related and network-related methods and systems. A more particular exemplary field is search engines.

### BACKGROUND ART

Search engines attempt to make large collections of information useful. Their widespread use is primarily for retrieving documents over wide area networks, e.g., the Internet. Search is the most widespread use of the internet currently, and search engines supply the foundations of most Web traffic. However, search engines are also used on local area networks and even on individual computers and servers, whose information storage capacities continue to grow.

Search engines remain most widely employed for users of the Internet, and the problems associated with Internet searching illustrate some difficulties with Internet search engines. Internet users basically have two ways to find the information for which they are looking: they can search with a search engine, or they can browse. As the number of Internet users and the number of accessible Web pages grows, it is becoming increasingly difficult for users to find documents that are relevant to their particular needs.

Efforts have been made to “personalize” the results for each user. Earlier work has focused on personalizing search results. One problem with search engines is that the collection of documents is so huge that most queries return too many irrelevant documents for the user to sort through. It has been reported that approximately one half of all retrieved documents are irrelevant.

Browsing has many of the same problems that plague search engines. Some problems are caused by the fact that language is complex and often imprecise, with single strings having multiple meanings. The knowledge models, or ontologies, that are used for browsing are generally different for each site a user visits, and even if there are similar concepts in a hierarchy, often pages categorized under “Arts” on one site, for example, will not be the same type of pages categorized under “Arts” on a different site. Not only are there differences among sites, but among users as well. One user may consider a certain topic to be an “Arts” topic, while a different user might consider the same topic to be a “Recreation” topic. While natural language processing has made strides in decoding complex sentence structures, such tools currently are not capable of efficient searching over the billions of pages of information in the Web. Also, unlike searching, which brings together information from many sites, browsing can usually be done only one site at a time.

One proposed solution for the problems plaguing traditional, string-based search engines is to encode more explicit semantics to bring meaning to internet search. An example of this solution is the Semantic Web. The Semantic Web relies on the encapsulation of human knowledge concerning one or more domains in a machine-processable form. Ontologies form one of the principal ways to provide this domain knowledge. Ontologies are formal representations of human knowledge about a particular domain encoded in a form that is machine processable. An ontology generally includes a class hierarchy (e.g., “is a”) and relationships among classes (e.g., “has a”). As example ontologies, a convertible “is a” car, while a car “has a” engine. Using information contained in the ontology, a computer can easily infer additional knowledge using relationships encoded in the ontology, e.g., a convertible has an engine.

However, to implement the solution provided by the Semantic Web, special tools have been needed to embed tags to mark up information content and to browse and search this information. The end user is burdened with the mark up of data content. This has slowed progress of semantic solutions such as the Semantic Web considerably. By contrast, traditional search engines, such as Google, work with virtually any Web browser and do not require data providers to take additional steps to make their data available beyond converting it to HTML. Due to the overwhelming popularity of such traditional search engines, and the number of Web pages created in traditional markup languages, a scalability problem is present. Thus, any new technology requiring more from either the information provider or the consumer will likely be very slowly accepted, if at all, and thus the efficacy of a search strategy using such new technology may be relatively limited.

### DISCLOSURE OF THE INVENTION

Embodiments of the present invention provide, among other things, systems and methods for populating a database. In an example method, an ontology is parsed to determine a plurality of keywords. A string-based search engine is utilized to perform a search of documents on a network based on the determined keywords, and at least one document is retrieved. A relation is established between the retrieved document and the ontology, and it is determined if the at least one document is to be stored in the database based on the established relation. If so, the document is stored in the database. The database can be used as a standalone or plug-in search engine for retrieving online documents.

### BRIEF DESCRIPTION OF THE DRAWINGS

FIG. 1 shows a network including a search engine according to embodiments of the present invention;

FIG. 2 shows an example architecture for a semantic search engine plug-in according to embodiments of the present invention;

FIG. 3 shows an example method for creating a search engine index cache for a semantic search engine according to embodiments of the present invention;

FIG. 4 shows an example database schema;

FIG. 5 shows an example front-end user interface method, according to embodiments of the present invention;

FIG. 6 shows an example user interface operation, in which a keyword relates to multiple domains;

FIG. 7 shows an example user interface providing a user query; and

FIG. 8 shows an example user interface providing search results.

### BEST MODE OF CARRYING OUT THE INVENTION

Embodiments of the present invention can be used to solve the scalability problem described above by combining the knowledge provided in an ontology with the flexibility of a traditional search engine. An embodiment of the invention provides, among other things, methods and apparatus for populating a database, such as a search engine cache, with domain-relevant objects such as documents located on a network, and methods and apparatus for retrieving an object.

In an example embodiment of the present invention, an internet search engine provides semantic search capabilities through a Web browser, including a standard Web browser. The search engine uses knowledge contained in ontologies to provide a domain specific search.

Embodiments of the invention provide a semantic search engine, more particularly a domain-specific and relation-based search engine and/or a semantic search engine plug-in. Particular embodiments of the present invention provide a front end for a search engine, such as a generally string-based search engine, that allows the existing search engine to be used as part of a semantic search engine for a particular domain providing more sophisticated, ontology-based searches. Results are more accurate and relevant to the particular domain, and are also returned within a broader context. Additionally, data resources need not describe their data using special mark up languages.

Embodiments of the present invention further provide a configurable semantic search engine that utilizes knowledge contained in ontologies to provide a domain-specific search tool. More particularly, with exemplary methods and software of the invention, ontology is used to constrain the domain and generate terms that will then be used by a different (e.g., traditional or string-based algorithmic) search engine. Because the ontology has a much richer representation of a particular domain, it can support reasoning and serve as the basis to build much more powerful heuristics that can be used by a string matching algorithm, such as that provided by a traditional search engine.

Thus, instead of using a traditional keyword search, an example semantic search engine according to embodiments of the present invention employs the relationships encoded in the ontology to evaluate and rank Web pages and other Web-based or network-based resources, such as databases. The results may be presented in the context of the ontology, which allows users to understand the relevance of a particular result. For example, an exemplary semantic search engine evaluates search results, e.g., Web pages, based upon context provided by ontology terms, which can include the ancestors, children, and properties of the ontology term.

Example embodiments are represented in search engines, or plug-ins to search engines, including traditional search engines, which make an example semantic search engine easily configurable for different domains. Such embodiments employ an ontology that may be generated as part of the semantic search engine, or that is generated separately, customized, and plugged-in to the semantic search engine. The ontology generally is used to define search terms for a string-matching algorithm, and for analyzing and presenting the results of a search. Thus, embodiments of the invention permit users with expertise in a particular domain to define their own domain specific search engine by defining an ontology.

It is preferred that the ontology be expressed in a manner (e.g., a language) that can be machine-processed, is capable of representing hierarchy and relations among aspects of a domain, and is capable of classifying elements of a data set. Preferred embodiments of the invention utilize an Ontology Web Language (OWL) standard for encoding the ontology. OWL supports definition of class axioms (e.g., one of, dataRange, disjointWith, equivalenClass, subClassof), Boolean combination class expression (e.g., unionof, complementof, intersectionof), arbitrary cardinality (e.g., min and max), and filter information (e.g., hasValue). Such a language allows classification of not only the object (such as a Web page), but also reasoning of the relations between the different classes, their parts and properties in the ontology, and the objects as the instances based on the content. However, it will be understood that other languages may be used for providing ontologies according to embodiments of the present invention. Example semantic search engines treat an ontology on a concrete level in which the search engine can analyze the definition of class axioms, Boolean expressions, cardinality, and filters. Embodiments may employ a traditional, string-matching search engine, e.g., Google, Yahoo, etc.

As a nonlimiting example, if two or more terms are entered directly into a traditional, string-matching algorithmic search engine, the search engine might use the terms with an AND operator or an OR operator along with other statistics to determine relevance to search for documents such as Web pages. As a more specific example, assume that a user wishes to search for a family car for purchase. The user may enter the keywords “family car” into a traditional search engine. The traditional search engine may use the terms “family” and “car” with an AND operator, and retrieve and rank Web pages based on the appearance of these two strings. Results may include, for example, magazines describing family cars, a definition of “family car”, guidelines for looking for a family car, etc. To further refine the search, a user may need to sort through multiple pages of irrelevant hits before locating a desirable Web page. Alternatively, a user may manually review one or more of the retrieved documents (thus manually generating a knowledge model) and determine if additional keywords may be useful for a better search. Both of these approaches can be quite time-consuming, especially if the search topic is complex, or if the topic or keyword is applicable to many different knowledge domains. Further, the resulting search is still generally limited to Web pages in which the listed keywords (strings) appear, ranked by the prominence of such words in the document.

By contrast, an embodiment of the invention can show how the search terms may be related by providing intermediate components and their relation to the entered search terms. If no direct relation between the search terms is determined, the search engine can compare other properties, such as axioms, Boolean expressions, cardinality, and filter and give the analysis based on the similarity and differences. For example, by considering the properties of a family car, more relevant search results can be retrieved, and a context in which to interpret results can be provided along with hits. Based on the results, a user can quickly peruse search results, and if necessary, can more easily modify the definition of “family car” or create a new definition for better search.

The exemplary semantic search engine plug-in can also be configured using a plug-in architecture so that it can apply to any of various subject domains (as nonlimiting examples auto, aerospace, pharmacy, biology, legal, etc.) Thus, due to the plug-in architecture, an exemplary search engine according to the present invention allows the instantiation of personalized context-based search engines. For example, by supplying a customized ontology, a customized semantic search engine can be realized according to embodiments of the present invention.

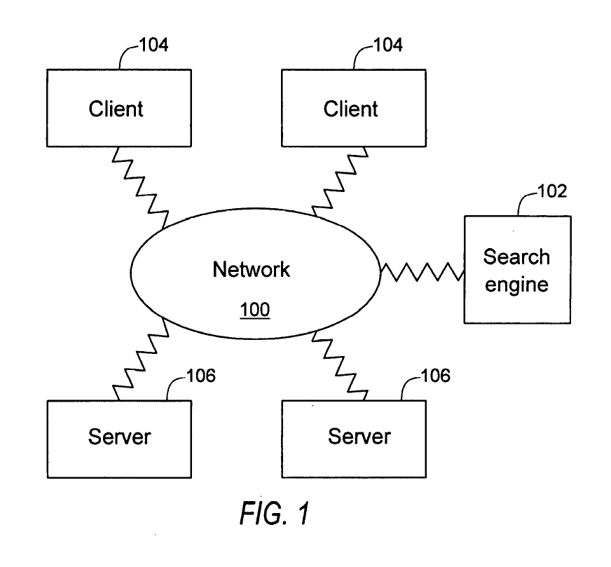

Turning now to the drawings, FIG. 1 shows a network 100 for object retrieval including a semantic search engine 102 according to embodiments of the present invention. The network 100 may include multiple clients 104 and multiple servers 106, though it is to be understood that clients may perform one or more of the functions of a server, and vice versa. Example networks 100 include, but are not limited to, a wide area network (WAN) including the internet, a local area network (LAN), a telephone network, a wireless network, an intranet, and others, including combinations of the above. A user working with a client device (such as, but not limited to, a computer or other networked device) accesses the network 100, such as the internet, through a Web browser. A semantic search engine 102 existing on one or more servers 106 or clients 104 (including, in some embodiments, the user's client device) is accessed, and the semantic search engine in turn preferably accesses a separate, traditional search engine (e.g., a search engine relying primarily on string algorithms for retrieving results).

The traditional search engine crawls the network to retrieve objects such as documents from various servers. Information relating to retrieved documents may be stored in a suitable repository, such as a database. Objects in the database may be referred to as instances. It will be understood that “server” may refer to multiple servers and “client” may refer to multiple clients. Connections within the network 100 may be any suitable wired or wireless connection.

A device acting as a server 106 or client 104 may include, for example, a computing device having a suitable processor, memory (RAM and/or ROM), suitable storage (including any known or to-be-known storage media), network interface (known or to-be-known), input devices, and output devices, connected by a bus. Those of ordinary skill in the art will be aware of more particular examples for device hardware components, and thus a detailed explanation is omitted herein. A “device” as used herein may include a single device or multiple devices.

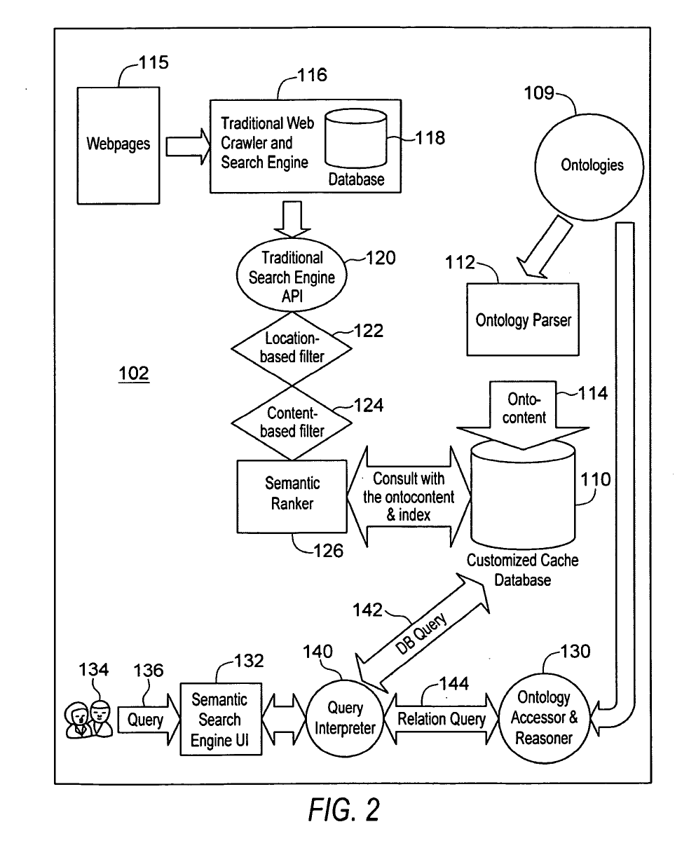

Referring now to FIG. 2, a semantic search engine 102 is shown, according to embodiments of the present invention. As stated above, certain embodiments of the present invention provide a plug-in to an existing search engine. The semantic search engine 102, whether a plug-in or a complete search engine, may be embodied in software or hardware, and may exist on the client side 104, on the server side 106, or on a combination of client and server. Methods of the present invention may be embodied in any suitable computer-readable media, firmware, hardware, software, a signal propagating though a network, machine-readable instructions, a memory, a computing or computer-based device configured to perform the present invention, or other ways.

A semantic search engine 102 according to embodiments of the present invention generally includes one or more ontologies 109, such as an ontology software library. The ontology 109 is a formalized knowledge model including term relationships and metadata. In an example embodiment, the ontology 109 includes, but is not limited to, an ontology encoded in web ontology language (OWL). OWL is an extension of the customized tagging schemes and RDF's (Resource Description Framework), which is a flexible approach to representing data. OWL formally describes the meaning of terminology used in Web documents and the relationships among terms in a form that supports reasoning.

The ontology 109 may be provided as a plug-in to the remainder of the semantic search engine 102, and this ontology affects other components of the search engine. Thus, providing a unique ontology 109 in turn effectively provides a unique semantic search engine. It is contemplated that various ontologies may be provided, either as part of the semantic search engine 102 or semantic search engine plug-in, or as an externally generated module that is plugged-in. An expert in a particular domain may thus prepare an ontology using suitable components, and supply the ontology, or a semantic search engine or search engine plug-in, for a user.

A database 110, such as a customized cache database, stores ontology terms, along with locators for networked objects, such as but not limited to uniform resource locator (URL) indexes, IP or other network addresses, file addresses, etc. An example customized cache database 110 is an Oracle database. It is to be understood that this database 110 may comprise one or multiple databases, and it is not necessary that the database be on the same device or same site as other components of the semantic search engine 102 or plug-in.

An ontology parser 112 extracts ontology content and relations from the ontology 109 and inserts then as ontology content (onto-content) 114 into the database 110. The ontology parser 112 may be embodied in a Java library (API), such as Jena Semantic Web Framework.

To retrieve documents such as Web pages 115, a traditional search engine 116, which may include a Web crawler, database 118, and search engine API 120, is provided or accessed. Any search engine having built-in heuristics that are tailored to a specific domain may be used. Example search engine APIs 120 include Google Search API and Oracle Ultra Search API. Because the semantic search engine 102 is not limited to a particular string-based search engine, and because one or all of the components of the semantic search engine may be networked, the other components of the semantic search engine may be embodied in a semantic search engine plug-in that operates on top of the traditional search engine 116 networked via any suitable connection and/or interface. Operation of a traditional, string-based algorithmic search engine will be understood by those of ordinary skill in the art, and thus a more detailed description will be omitted herein.

A location-based filter 122, implemented by example by Java API, is provided for excluding irrelevant documents based on their location. For example, the location-based filter 122 may refine a search query to exclude certain locations. A content-based filter 124, which may implemented by Java API, preferably compares a keyword occurrence on a retrieved document with keywords in an ontology model and determines whether to maintain a particular document in the customized cache database 110. If the document is maintained, a semantic ranker 126 consults with the onto-content 114 and index in the customized cache database 110. The semantic ranker 126, which may be implemented by Java API, Protege, or Oracle API, for example, assigns semantic rankings to the documents based on the relevance between the document contents and the ontology definition, properties, and surrounding structure.

To generate queries for a user, an ontology accessor and reasoner 130, which may be implemented, for example, in Protege, Jena, or Pellet, accesses the ontology 109 programmatically and reasons the ontology structure by its properties. A semantic search engine user interface 132, implemented by example as a Java Servlet, Tomcat Web Application Server, or JSP, provides a user interface for a domain-specific search. As a nonlimiting example, the user interface 132 may provide a portal for a user's 134 ontology registration and Web site registration, for receiving a query 136, and for presenting results in a viewable document (e.g., Web page) format. A query interpreter 140, implementable in Java, for example, interprets the user query 136 as a database query 142 and an ontology query 144.

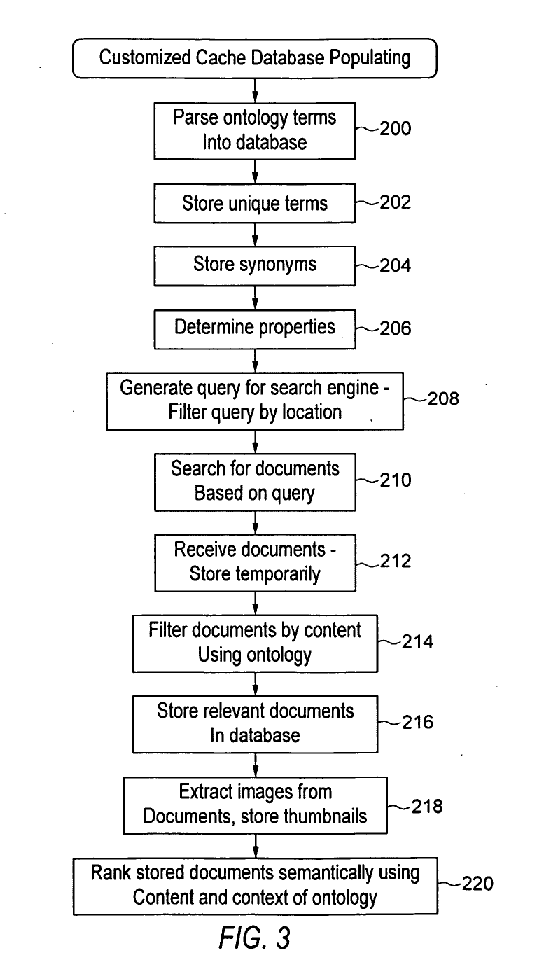

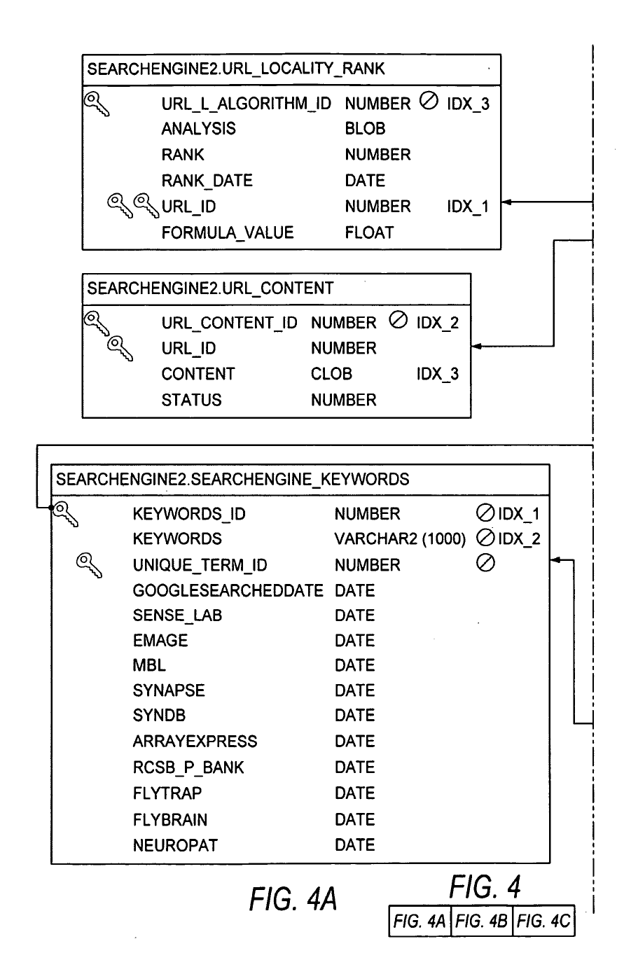

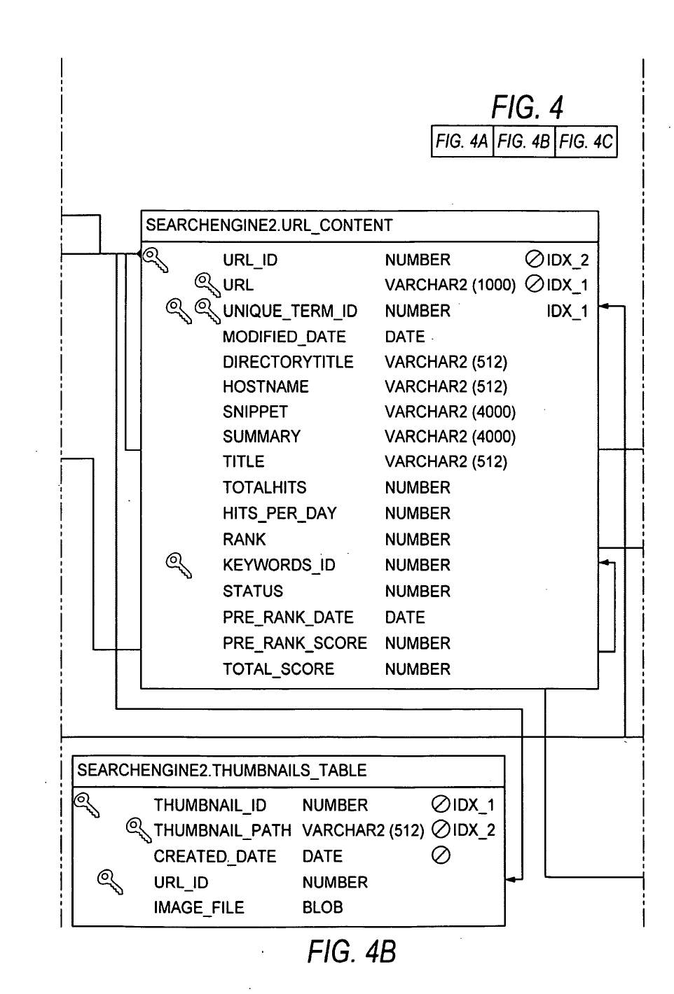

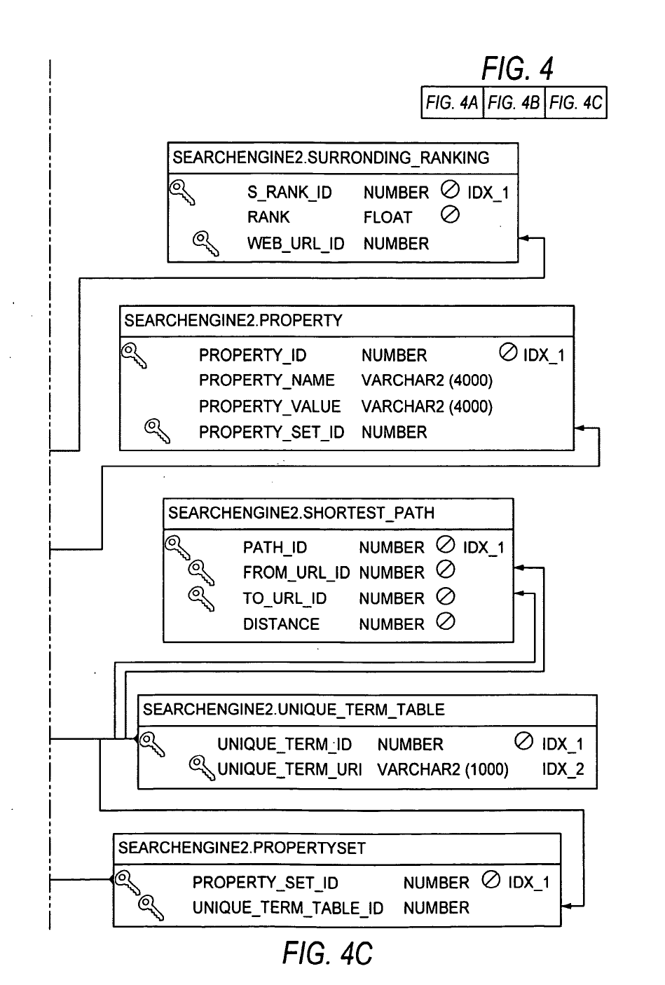

FIG. 3 shows an example method for populating the database 110 with objects, such as Web documents, to prepare a customized index cache for searching, according to an embodiment of the present invention. Given an ontology 109 plugged-in to the semantic search engine 102, the ontology parser 112 parses 200 all ontology terms into the database 110. An example database schema is shown in FIG. 4. The database 110 includes classes for documents (identified by URL), URL content, locality rank, property, shortest path, surrounding ranking, thumbnails, keywords, property set, and unique terms.

A particular Web document (e.g., identified by URL) may have one or more keywords, and the keywords may include one or more unique terms. As a result of parsing the ontology, an example data table in the database 110 stores 202 the unique terms appearing in the ontology 109. Additionally, another data table stores 204 the term's synonyms in the ontology 109 referring to the unique term. Properties of the unique terms and synonyms of the unique terms' properties are also determined 206 by parsing the ontology 109 (such as the classification and hierarchy).

Next, a customized cache of relevant objects, e.g., documents such as Web pages, is created. In an example embodiment, the string-based algorithmic search engine (e.g., a traditional search engine 116 and API 120) is used to search for relevant documents 115 using the unique terms of the ontology and their synonyms as keywords. Example queries are formed 208 iteratively using the unique terms and synonyms. It is preferable to confine the source providers or Web sites that can provide the relevant results in the particular domain. The location-based filter 122 excludes irrelevant documents based on their location, e.g., by URL. For example, if the knowledge domain concerns biology, the semantic search engine 102 will not crawl a commercial (.com) website such as “yahoo.com”.

The string-based algorithmic search engine 116 searches 210 for the keywords from particular network locations, such as Web sites. The resulting documents are received 212 and stored temporarily for analysis. The content-based filter 124 filters out 214 irrelevant documents and maps 216 relevant documents as instances in the domains. Documents and their locations (e.g., URLs) are stored into the database 110. The content-based filter 124 preferably compares the keyword occurrence on a retrieved document with the keywords in the ontology model. For example, for each unique term searched for in the string algorithm-based query 208 above, and for every synonym of that unique term also searched for using the string algorithm-based query, the retrieved web document may be queried for the unique term, its synonyms, its descendants, its properties, and synonyms of properties. The content-based filter 124 may determine the relations based on the ontology (the properties are part of the ontology). For each of these queries, a value is provided for occurrence of the particular word searched. Relevancy is provided by a threshold sum of occurrences for all terms related to the unique term.

If the document's content is determined to be relevant, the semantic search engine will store the document 216 within the customized cache. Preferably, separate caches are created for images and Web pages. Similar to the method employed by Google Images, for example, from the collected URLs, images are extracted 218 from the located Web pages and converted into image thumbnails. The image thumbnail paths are stored in the database 109.

The cached documents are then ranked 220 based on content and the context of the ontology 109. More particularly, the semantic ranker 126 assigns semantic rankings to the documents based on the relevance between the document contents and the ontology definition, properties, and surrounding structure. Additionally, the overall site (e.g., website) may be ranked by calculating the overall relevance of the site for each of the ontology terms.

In a nonlimiting example ranking algorithm, the semantic ranker 126 converts the retrieved document into a customized mapping file, referred to herein as meow-html. For example, assume a Web page containing the following sentence “Rotation loop of maximum intensity projection of spiny neuron in nucleus accumbens. Some dendrites are incomplete due to the thickness of the section.” The semantic ranker 126 references an ontology 109, for example “The Subcellular Anatomy Ontology (SAO)” and converts the sentence into a binary file stored into the database 110:

“0 0 0 0 0 0 0 sao:sao638749545 sao:sao1417703748 0 sao:sao1702920020 0 0 0 0 0 0 0 0 0 0 0 0 sao:sao1211023249 0 0 0 0 0 0 0 0 0.”

### Where,

sao:sao1417703748=Neuron
sao:sao1702920020=nucleus
sao:sao1211023249=dendrites

### 0=Unknown

The semantic ranker analyzes the converted file for surrounding neighbors. An example pseudocode is provided below:

```
//////////////////////////////////////////////////////////////////////
// pseudocode
For each potential term[ ] in the meow-html:
    Value1 = value1 + Is sibling(term[i], term[j]);
    Value1 = value1 + Is ancestor(term[i],term[j]);
    Value1 = value1 + Is descendent(term[i], term[j]);
    Value1 = value1 + has shared property(term[i], term[j]);
end For loop
return value
//////////////////////////////////////////////////////////////////////
```

A second evaluation considers term locality, as shown in the following pseudocode:

//////////////////////////////////////////////////////////////////////////
//pseudocode
For each potential term[ ] in the moew-html:
Value2 = value2 + Is sibling(term[i], term[j]) divided by
html_distance(term[i],term[j]);
Value2 = value2 + Is ancestor(term[i],term[j]) divided by
html_distance(term[i],term[j]);
Value2 = value2 + Is descendent(term[i], term[j]) divided by
html_distance(term[i],term[j]);
Value2 = value2 + has shared property(term[i], term[j]) divided by
html_distance(term[i],term[j]);
End For loop.
Return value2
//////////////////////////////////////////////////////////////////////////

The pseudocodes above include the following functions:

Is sibling—determine whether two terms are siblings and returns a value
Is ancestor—determine whether term[i] is an ancestor of term[j] and returns a value based on how many levels they are separated.
Is descendent—determine whether term[i] is a descendent of term[j] and returns a value based on how many levels they are separated.
Has shared property—determine whether term[i] and term[j] are related in certain properties.
Html distance—Evaluate how far two terms, the term[i] and term[j] are separated.

Given the evaluations above, a final semantic ranking is provided as follows:

Semantic ranking=Surrounding neighbor evaluation (term[i],term[j])+Term−locality sensitive evaluation (term[i],term[j])

The semantic rankings are stored within the cache 110 for each of the document URLs, and by ontology unique terms.

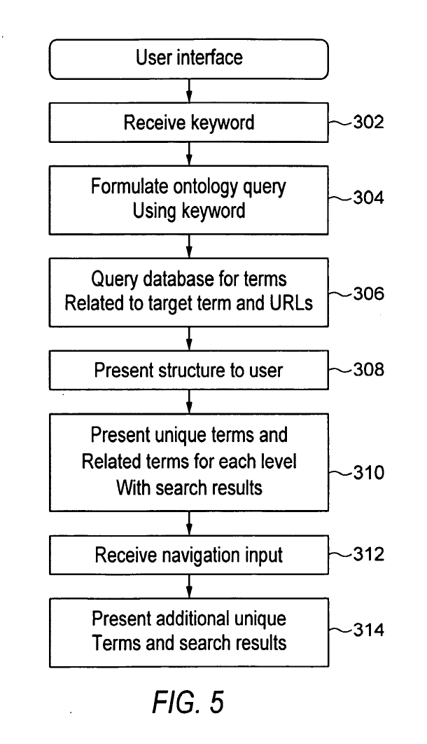

With the customized cache database 110 prepared, a user can search the cache using a portal similar to a portal for a traditional search engine. FIG. 5 shows an example operation of the user interface for retrieving a document, according to an embodiment of the invention. To interface with a user, the user 134 preferably enters one or more keywords in a query 136 related to the domain of interest, similar to interfacing with a traditional search engine, and the keywords are received 302 by the semantic search engine user interface 132. The keywords entered may relate to the unique terms, synonyms, and/or properties.

In certain embodiments, different syntax or input method may be used for indicating whether a unique term, synonym, or property is a subject of the query. As an example, say that a user wishes to look for cells using the neurotransmitter GABA. The user enters the keyword “cell” followed by [GABA]. The query interpreter 140, referring to the ontology, translates this query into “cells that have property GABA” and retrieves the results from the ontology 109 and database 110, with a ranking indicating the likely accuracy of the search results for that term. Clicking on a link returns the results for that concept, and also the portion of the ontology graph for that concept. In this case, the user 134 can see that the “Medium spiny neuron has neurotransmitter GABA”, thereby understanding why this concept was returned. By contrast, entering these two terms into a traditional, string-based search engine will likely generate a list of pages where the two searched-for words co-occur, but without any understanding of why they co-occur.

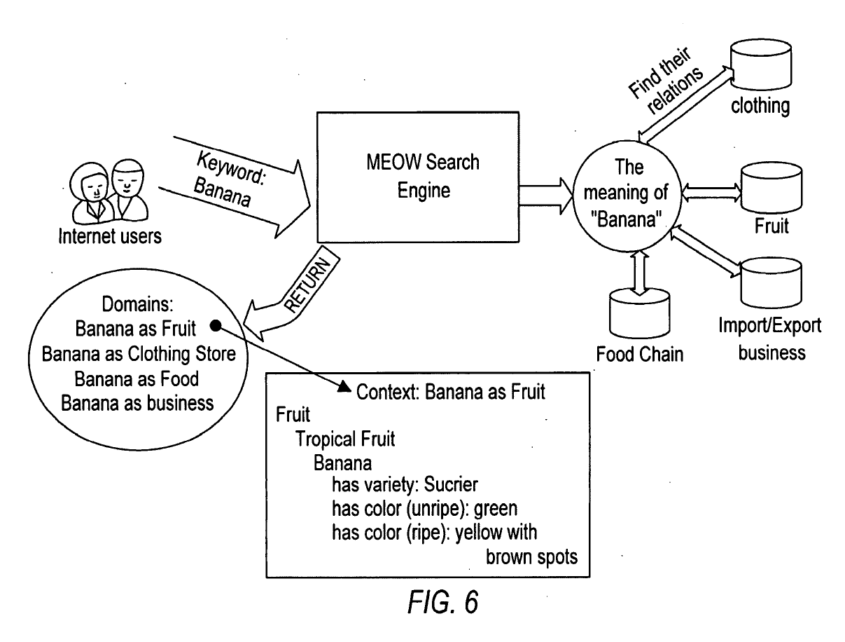

Multiple domains and ontologies may be used in a particular cache, in which case an initial query by a user may result in one or more possible domains being presented to the user for selection. For example, as shown in FIG. 6, a user searching for keyword “banana” results in the search engine 102 finding relations between “banana” and domains such as clothing, fruit, import/export business, and food chain. The multiple domains are returned to the user for review and selection. If the user selects, say, “Banana as fruit”, a portion of the ontology is returned showing context of “Banana” in that domain.

As another search method, the user may input a definition, which is then compared to the ontology to determine if any unique terms apply. In yet another input method, a query may be entered as pairs of unique terms related by a property. This acts analogously to a “subject-verb-object” for generating a query.

Given a particular domain, the query 136 is formulated 304 by the query interpreter 140 based on the received keywords and/or any syntax or special inputs used. The search engine 102 consults with the ontology 109 for the meanings or interpretations of the received keywords. If there is an exact match with an ontology term, the search engine 102 will return the set of terms 306 related to the target term according to the knowledge model, along with the URLs and/or image results. For example, if the query matches a unique term or its synonyms as stored in the database, a unique term ID is retrieved. The unique term ID is used to determine the structure surrounding the unique term. If there is no match, the user is notified, and other search results (such as traditional search engine results) are presented.

Given a particular unique term ID, the structure is presented 308 to the user as a result. Unique terms and related terms for one or more levels are presented 310 with results for those terms. A search engine Web page is created that returns the URLs and image results. The user can navigate the presented structure 312 to move up or down in hierarchy, thus providing new results (unique terms). For example, the user can select links within the structure to move up or down levels and thus to select new unique terms 314.

If more than one term is presented, and the combined terms themselves do not provide a unique term, one of the terms is analyzed to determine if it is related to the other term(s). If so, this term's structure is presented to the user. If the query matches more than one unique term or synonym for a unique term, the user interface presents definitions for each of the unique terms found (based on the unique term IDs), and asks the user to select from among the results.

The number of levels of depth from the selected unique term that are presented 310 to the user with search results may depend, for example, on the particular configuration of the user interface 132. The information returned to the user 134 preferably includes the location (e.g., URL), a description of the retrieved document (and any associated thumbnail image), and a portion of the knowledge model. The user 134 may then navigate 312 the hierarchy to select a document or refine a search, with awareness of the context of the documents. Starting with the selected unique term, for example, the documents having the highest semantic ranking may be presented to the user, including their location, description, thumbnail if available, along with the unique term itself. Then, at the first level of depth, the related terms (e.g., descendants) at that level are presented to the user, with the documents having the highest semantic ranking for that term, along with location, description, thumbnail, and term listing. This continues for the number of levels provided by the configuration.

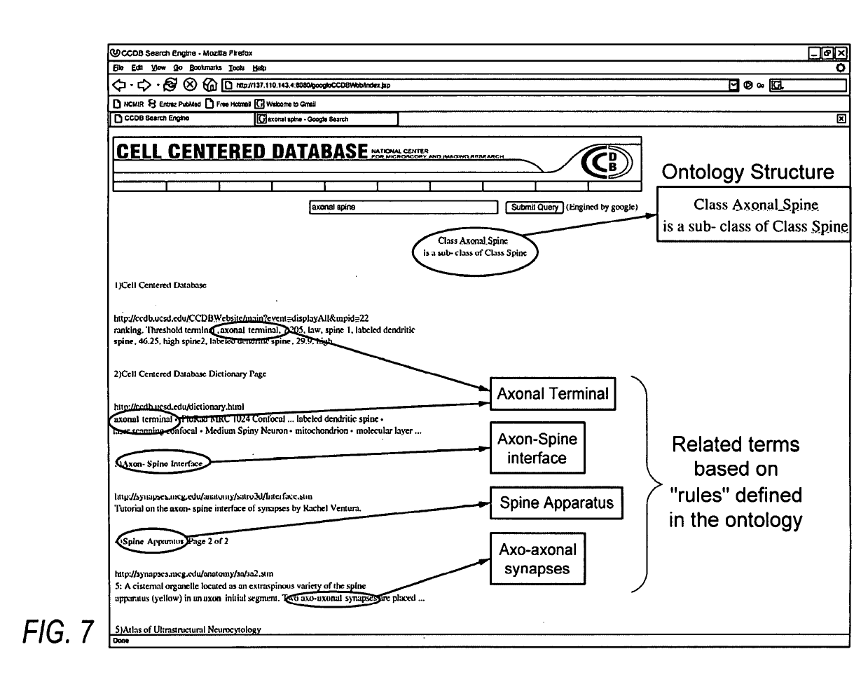

An example results page is shown in FIG. 7. The related terms are presented in the form of a hierarchy, and include links. Clicking on a link, such as a particular term in the hierarchy, will display results specific to that term. For example, in the results page shown in FIG. 7, the keywords “axonal spine” are entered as a query in the user interface. The semantic search engine 102 returns a portion of an ontology structure, indicating class “axonal spine” is a sub-class of class “spine”. Related terms are generated based on rules in the ontology, such as “axonal terminal”, “axon-spine interface”, “spine apparatus”, and “axo-axonal synapses”. Each of these related terms includes a link to a retrieved Web document.

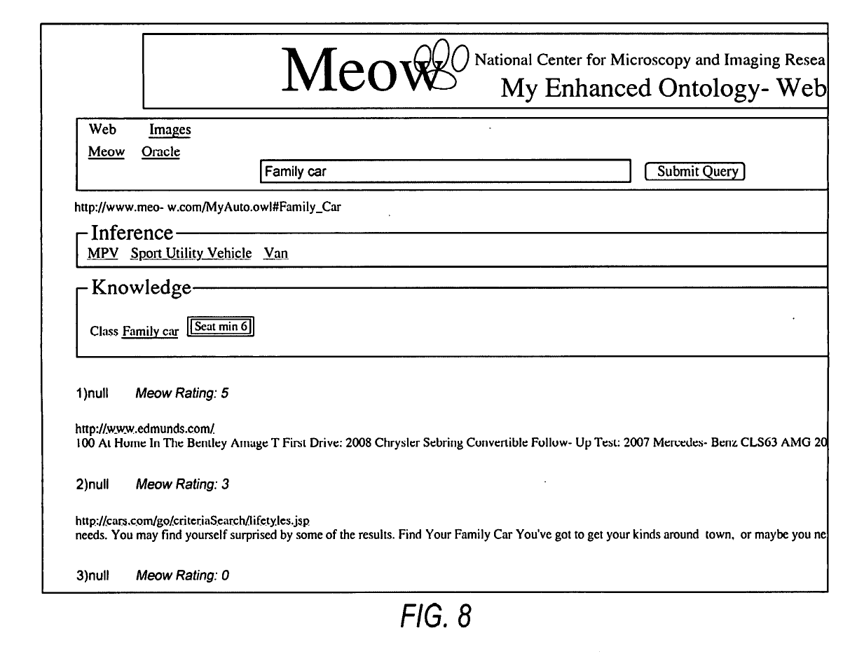

Another example results page is shown in FIG. 8. The user query “family car” results in displayed inference based on the properties gathered from a knowledge model, including “MPV”, “Sport Utility Vehicle”, and “Van”. A knowledge window is also shown, giving a user an opportunity to refine the knowledge model, such as by modifying a definition or creating a new definition. For example, the displayed knowledge model indicates that a “family car” has a seat minimum of 6. This may be refined, such as by defining a different seat minimum, such as 4. Displayed results related to the concept “family car” are shown, along with rankings.

Semantic search engines according to embodiments of the present invention provide, among other things, a more accurate and flexible search using a shared knowledge environment. The system uses the meaning of words to improve searching. Users, including the one using the semantic search engine at a particular time, or other users, can contribute knowledge to improve a search. Individual semantic search engines, plug-ins, and/or ontologies may be owned by users, who can customize them to produce better results. Alternatively or additionally, semantic search engines, plug-ins, and/or ontologies may be prepared separately, delivered, and imported. These may be sold, stored, posted for collaborative development (e.g., a wiki), etc. A combination of these two approaches is also possible. For example, a template ontology and/or resulting search engine may be produced, and then customized by a user. Template ontologies may be used to generate other ontologies directly. A community of search engines may be made available. Search engines may be customized for private industry or private data stores so that the search engine unlocks content accessed by those with authorization. Personalized “search personalities” can be made available, and combined to enhance their profile. Synergistic benefits may result from combining multiple profiles.

Example search engines according to embodiments of the present invention may be used as complementary technology for existing search engines. For example, users interested in particular domains can utilize the inventive semantic search engine to perform research in such domains. Example domains include, but are not limited to: medicine, law, pharmaceutical research, financial research, consumer research, etc. The specific knowledge contained in the ontology can perform more relevant searching while providing search results in context. The example semantic search engine thus avoids forcing a user to review search results and manually attempt to understand the domains (in essence, a manual ontology) before being able to refine his or her search.

The example semantic search engine may also be used to search intranet or Intra-web page documents. Such documents traditionally have been very difficult to search using traditional search engines. Good results are rarely returned, and if they are, it is difficult to quickly determine their relevance. By creating a model of, for example, a company's intranet or Web page site, one can perform a much better search and provide results in context. Other applications for an example semantic search engine include virtual reality worlds.

While various embodiments of the present invention have been shown and described, it should be understood that other modifications, substitutions, and alternatives are apparent to one of ordinary skill in the art. Such modifications, substitutions, and alternatives can be made without departing from the spirit and scope of the invention, which should be determined from the appended claims.

Various features of the invention are set forth in the appended claims.

1. A method for populating a database, the method comprising:
parsing an ontology to determine a plurality of keywords;
utilizing a string-based search engine to perform a search of documents on a network based on the determined keywords;
retrieving at least one document;
establishing a relation between the retrieved document and the ontology;
determining if the at least one document is to be stored in the database based on said established relation, and if so, storing the document in the database.

2. The method of claim 1, further comprising:
ranking the stored document based on the plurality of keywords and the ontology, and storing said ranking.

3. The method of claim 1, wherein said parsing comprises:
parsing the ontology for at least one unique term and at least one synonym for the unique term, said at least one unique term and at least one synonym providing the keywords.

4. The method of claim 3, wherein said establishing a relation comprises:
searching the retrieved web document for the at least one unique term, at least one synonym, and at least one related term based on the ontology;
determining the number of occurrences for the at least one unique term, at least one synonym, and at least one related term;
determining if a sufficient number of occurrences is present in the retrieved document.

5. The method of claim 4, wherein the ontology is written in a programming language expressing at least one of ontology class axioms, Boolean combination class expressions, arbitrary cardinality, and filter information.

6. The method of claim 1, wherein the ontology comprises a plug-in.

7. A method for finding a document over a network, the method comprising:
receiving a search query including at least one keyword;
querying a database based on said received search query, wherein the database comprises terms parsed from an ontology, documents, and expression of relations between the documents and the ontology;
retrieving at least one document;
presenting said retrieved document and at least a portion of the ontology.

8. The method of claim 7
wherein said querying a database comprises querying the terms parsed from the ontology;
wherein said retrieving at least one document comprises:
determining at least one unique term in the ontology based on said querying a database;
retrieving at least one of the documents based on the expression of relations between the documents and the ontology, said at least one of the documents being more relevant with respect to the at least one unique term than other documents stored in the database.

9. The method of claim 8, wherein said presenting said retrieved document and at least a portion of the ontology comprises:
presenting the at least one unique term;
presenting a location of said retrieved document;
presenting a portion of the ontology structurally near the at least one unique term.

10. The method of claim 9
wherein said presenting the at least one unique term comprises presenting a plurality of unique terms;
further comprising:
receiving a selection from among the presented plurality of unique terms to select one of the unique terms;
presenting a portion of the ontology structurally near the selected one of the unique terms.

11. The method of claim 7, wherein said receiving a search query comprises at least one of receiving a text keyword and receiving a query indicating a relationship between one or more keywords.

12. A system for searching for online documents, the system comprising:
an ontology for a knowledge domain;
a database;
an interface for parsing said ontology to determine at least one term and populating said database with at least one document, the at least one term, and an expression of relation between the document and the ontology;
a user interface for receiving a query and searching the populated database based on the query.

13. The system of claim 12, wherein said ontology is written in a programming language expressing at least one of ontology class axioms, Boolean combination class expressions, arbitrary cardinality, and filter information.

14. The system of claim 12, wherein said interface comprises an application programming interface.

15. The system of claim 12, wherein said ontology comprises a plug-in.

16. The system of claim 12, wherein said interface is configured to query a string-based algorithmic search engine based on the determined at least one term.

17. The system of claim 16, further comprising:
a string-based algorithmic search engine for receiving the query from the interface and retrieving at least one document.

18. The system of claim 16, wherein said interface comprises a content-based filter for analyzing at least one retrieved document from the string-based algorithmic search engine to determine its relevance with respect to the at least one term and a semantic ranker to rank the at least one retrieved document based on the at least one term.

19. The system of claim 16, wherein said user interface is configured to retrieve at least one document from the database and to present the retrieved at least one document and a portion of the ontology.

20. The system of claim 12, wherein the system comprises a plug-in for a search engine.

21. A method for a user to find objects in a set of data across a network, the method comprising:
utilizing a programming language with ontology class axioms, Boolean combination class expressions, arbitrary cardinality, and filter information to
classify elements of a data set,
establish relations between different classes within the dataset,
establish relations between the parts of the data set and their ontologies,
establish elements of the data set as instances, and
provide a search based on domain and relation; and
utilize a keyword-based search engine to conduct the search.

22. The method of claim 21, wherein the objects comprise Web pages, and wherein the network comprises the internet.

23. A system for performing the method of claim 1.

24. A system for performing the method of claim 7.

25. A system for performing the method of claim 21.
